(19) United States
(12) Patent Application Publication
(10) Pub. No.: US 2010/0312886 A1
(43) Pub. Date: Dec. 9, 2010

(54) SYSTEM FOR DETERMINING AND ANALYZING ENCOUNTER DATA

(76) Inventors: Gabriel Yoran, Berlin (DE); Bastian Pfister, Berlin (DE); Lukas F. Hartmann, Berlin (DE)

Correspondence Address: 24IP LAW GROUP USA, PLLC, 12 E. LAKE DRIVE, ANNAPOLIS, MD, 21403, US

(21) Appl. No.: 12/809,693

(22) PCT Filed: Dec. 16, 2008
(86) PCT No.: PCT/DE08/02099

§ 371 Date: Aug. 18, 2010

(30) Foreign Application Priority Data
Dec. 19, 2007 (DE) 10 2007 063 433.3
Aug. 26, 2008 (DE) 10 2008 039 665.6

(51) Int. Cl. G06F 15/173

(52) U.S. Cl. 709/224

(57) ABSTRACT

The invention relates to a system and a method for identifying encounters of the users of a system, wherein the user group comprises active and passive members. A system for the identification of encounters of users of a system is provided, wherein the user group comprises active and passive members, with a central memory for linking identification means to the active and passive members in a registration step and active members, detecting via the client encounters with other members and/or getting directly in contact with active and/or passive members, and passive members, who are identifiable via the identification mean as members of the system and active members being mediators of encounter information, mediating either directly to active and/or passive members or indirectly through different passive members encounter information, by transmitting the respective encounter of an active member with at least a first and second passive member to the central memory, which informs via suitable communication means the passive members about their encounter.

### FIELD OF THE INVENTION

The invention relates to a system and a method for identifying encounters of the users of a system, wherein the user group comprises active and passive members.

### BACKGROUND OF THE INVENTION

The term networking usually designates personal or business interactions with other people. Especially with regard to business aspects this manner of public relations gained an enormous meaning within the last years. So-called social online systems (or social networks) are already part of professional public relations, which takes also place in electronic form, in particular in the Internet.

Existing interactive social networks want to show presence on mobile terminals, but often they focus on mobile websites. The potential of mobile devices, namely to discover other members everywhere and at every time, is thereby not sufficiently tapped.

A mutual recognition of members of mobile social online systems in the meaning of existing solutions is restricted to the communication of active components. So far known solutions have a problem with the technical infrastructure, because access to the Internet via a mobile is not suitable for the majority due to the related costs in many regions of the world. Additionally, not all members of interactive solutions have compatible mobiles or are able to install software on it or are not willing to pay the non-transparent charges of the mobile providers. Solutions like GPS are expensive and not practicable (because the terminal devices are rare, the GPS use is power consuming and GPS does not or only work in a limited manner in defined areas).

The JP 2002-251567 describes a method for the transmission of commercials or advertisements. Registered users, who are designated as active users, can place advertisements and forward them through passive users. A passive user in the disclosed system has to agree before the transmission. Within this method the connected active and passive users knew each other.

The U.S. 2005/0138576 A1 discloses an interactive system for the integration of devices in a network, wherein a so-called active device can do the integration of so-called passive devices. The system, which is disclosed in this document, serves only for the integration of devices into a network.

The U.S. 2005/0038876 A1 describes a wireless communication system, wherein users can be connected directly with each other. Mobile devices of users with similar interests can be connected in real time with each other. This system is based on the direct interaction respectively the establishment of a direct mutual interaction of users with matching private or business interests.

### BRIEF DESCRIPTION OF THE INVENTION

Coming from the state of the art it is an objective of the invention to provide a method and a system, which avoids the disadvantages of the known solutions from the state of the art.

According to the invention a method is provided, comprising a system and a computer program for the detection of encounters between members although the device of a so-called passive member does not require a computer program (client) at the time of the encounter. Active members of the system work as mediators of contacts, also between passive members.

Part of a system within the sense of the present invention is a registry step, wherein all members, whether active or passive, are allocated to identification means. Preferably the Bluetooth-ID of a mobile is used, because a mobile is usually located at the same place as a registered user. Thus, it is clearly determined, to which member the mobile belongs, which has sent its Bluetooth ID.

Within the sense of the present invention users of a mobile client are designated as “active members”. Members, which are merely detected via active members, namely via the Bluetooth interaction of their mobile and who are indirectly connected with a server or a central memory, are designated as “passive members” in the sense of the invention. Active members are acting for a system according to the invention as mediators of information related to encounters and fulfil a function of a “relay”, which detects on one hand encounters and transmits them in the direction of a central memory and on the other hand transmits directly information about encounters or transmits information about encounters of members received from the central memory. Thus, the active members are necessary, in order to mediate information of encounters in two directions respectively to forward them.

However, passive members are also temporal and spatial relevant: The temporarily displaced encounter of a first and a second active member with the same passive member can be used to detected a missed encounter of both active members. In this case information about an encounter is generated via a passive member.

A “contact” or an “encounter” within the sense of the present invention means, that two persons are temporal in vicinity of an active member, so that the information about the encounter can be detected and forwarded. The system and method of the present invention function as a temporal detection of encounters or contacts, but the members do not have to be in the same room or at the same place. Furthermore, it is still possible that the present system is used for a spatial detection of encounters or contacts. For this purpose components are necessary suitable for localisation of the members. This is for instance possible by using spatial positioning of a mobile.

The central memory of a system according to the invention is preferably constructed as a server, for which reason in the context of the present invention instead of “central memory” the term “server” is used.

As MoHED (Mobile Hub for Encounter Detection) within the present invention a client is designated comprising the technology, which is used on the mobile device of an active member, wherein the technology serves for the detection and/or mediation of encounter information.

### DETAILED DESCRIPTION OF THE INVENTION

A system for the identification of encounters of users of a system is provided, wherein the user group comprises active and passive members, with a central memory for linking identification means to the active and passive members in a registration step and active members, detecting via the client encounters with other members and/or getting directly in contact with active and/or passive members, and passive members, who are identifiable via the identification mean as members of the system and active members being mediators of encounter information, mediating either directly to active and/or passive members or indirectly through different passive members encounter information, by transmitting the respective encounter of an active member with at least a first and second passive member to the central memory, which informs via suitable communication means the passive members about their encounter.

It is further intended that the identification mean is linked to a personal profile of the respective member. In addition the identification mean is allocated to a communication mean, preferably a telecommunication device, mobile, PDA, notebook or a Smart Phone. It is a purpose that the identification mean is preferably located in spatial vicinity of the member and has an identification number. It is intended that the identification number is a Bluetooth identification number, MAC-ID, telephone number, IMEI or any other numerical, clearly allocatable identifier. This means that also that license numbers or similar numerical numbers, which can be allocated to a person, are suitable as identification means.

It is intended that the communication means of passive members are connectable via Bluetooth-, WLAN or other wireless connections and that the communication means of active and passive members detect automatically encounters with other members and active members transmit the automatically registered encounters to the central memory.

According to the invention the central memory has a relational operator, which is able to align transmitted encounters in spatial respect. Alternatively it is intended for the relational operator that transmitted encounters are aligned in temporal respect, wherein the combination of a spatial and temporal alignment is also possible.

In a further embodiment of the system according to the invention an alignment with respect to consistency of personal profiles as well as the generation of relational profiles is intended.

According to the invention an embodiment is intended with an analysis operator allocating to different members a temporal and/or spatial index and analysing the indexes with regard to consistency, wherein falling below a temporal and/or spatial threshold causes a connection manager to transmit a message about the encounter to the related members. It is possible that the connection manager can only transmit an encounter after evaluating the relational profiles and exceeding a profile-based threshold.

It is further possible that a passive member, which received a message about an encounter, may get through the relational manager access to the content of the relational profiles of the allocated members in case that the operator of the system allows access, wherein the allowance of the operator may depend from the payment of a fee. However the allowance may depend from the payment of a membership fee to the operator of the system.

It is intended according to the invention that access to the relational profile of an allocated member may be carried out via SMS and/or MMS and/or the Internet.

According to the invention system it is intended that the index threshold is freely definable or an encounter of order two in temporal or spatial dimension will be defined by a fuzzy-logic.

A further objective of the invention is a method for the identification of encounters of users of the system, wherein the user group comprises active and passive user and in a registration step an identification mean is linked with the active and passive members in a central memory and only active members are able to detect via the client encounters with other members and/or getting directly in contact with active and/or passive members, and passive members are identifiable via the identification mean as members of the system and encounter information are transmitted by active members either directly to active and/or passive members or indirectly to different passive members, by transmitting the respective encounter of an active member with at least a first and second passive member to the central memory, which informs via suitable communication means the passive members about their encounter.

In an embodiment of the invention an identification mean may be used, which was previously linked to a personal profile of the respective member. It is intended that the identification mean may be allocated to a communication mean, preferably a telecommunication device, mobile, PDA, notebook or a Smart Phone.

It is further intended according to the invention that the identification mean is preferably located in spatial vicinity of the member and has an identification number.

Furthermore it is intended according to the invention that as identification number a Bluetooth identification number, MAC-ID, telephone number, IMEI or any other numerical, clearly allocatable identifier may be used. But it is also possible to use any other identifier, which can be clearly allocated to a member of the user group.

It is intended according to the invention that the communication means of passive members are connected via Bluetooth-, WLAN or other wireless connections and further that by the communication means of the active and passive members automatically encounters with other members are detected and by active members the automatically registered encounters are transmitted to the central memory.

In an embodiment of the invention it is intended that a relational operator of the central memory is used to align the transmitted encounters in temporal and/or spatial respect.

Alternatively the relational operator of the central memory may be used to align transmitted encounters with respect to consistency of personal profiles and to generate relational profiles.

It is further intended that an analysis operator allocates to different members a temporal and/or spatial index and analyses the indexes with regard to consistency, wherein falling below a temporal and/or spatial threshold causes a connection manager to transmit a message about the encounter to the related members. As an alternative to the analysis in temporal and/or spatial respect it is intended that the connection manager transmits only an encounter after evaluating the relational profiles and the exceeding of a profile-based threshold.

In a further embodiment of the method according to the invention it is intended that a passive member, which has received a message about an encounter, gets through the relational manager access to the content of the relational profiles of the allocated members in case that the operator of the system allows access. The allowance of the operator may depend from the payment of a singular or regular fee like a membership fee.

It is advantageous that access to the relational profile of an allocated member is carried out via SMS and/or MMS and/or the Internet, in doing so the index threshold is freely definable or an encounter of order two in temporal or spatial dimension can be defined by a fuzzy-logic.

The use of a system or a method according to any of the preceding claims is intended for the transmission of business contacts, especially at exhibitions, fairs or conferences.

Further the use of a system or a method according to the invention is intended for the transmission of private contacts, especially in discotheques, clubs, bars or at festivals and celebrations as well as at sportive or cultural events.

It is intended for instance that visitors of a fair may register before the fair starts on a webpage in order to get information about encounters with other visitors of the fair via client, SMS or email.

An exhibitor of a fair may record visitors on his stand with a system according to the invention in order to get in contact with them later on. Alternatively, the system according to the invention may be used to count the number of visitors.

In the field of private contacts the use of the system according to the invention would make sense to become acquainted with mutual friends or people with similar interests. This includes the search for people with identical sexual interests.

During events like parties or celebrations, for instance weddings, the system according to the invention may be used to allow people with identical interests to meet without the necessity that they knew themselves before or met before.

It is self-understood that the system according to the invention is able to arrange matchmaking or speed-dating parties. Finally the presence of one active member is sufficient to mediate encounters. Advantageously the organizer of the event arranges the presence of the active member. Thus security forces or photographers may be supplied with devices making them to mediators of encounters or contacts.

A system or a method according to the preceding embodiment may be used for marketing, trend or opinion research as well as for the evaluation of promotions.

Outdoor advertiser may control via the link of a Bluetooth-ID with a profile, which passerby passed through which poster/citylight (promotion success control).

Retail seller have the possibility to detect via Bluetooth the visitors of defined shops (automatically or manually by promotion teams), in order to provide afterwards information or sales messages on a webpage, via email or in any other suitable manner.

Opinion researchers have the possibility to realize or analyze trends, so that it gets traceable, which groups of spatial proximal users used or disseminated which sticker (small graphics with comment or discussion function, which may user stick to their profile)—and by this: which theme they have set.

Despite this the use of a system or a method is intended for carrying out interactive games. Bluetooth devices, which are not linked by their users actively with a profile, will be allocated after their first detection with a profile. Thus the devices will be recognizable, which is a prerequisite for alternate reality games (ARG), based on the system according to the invention. In such an ARG the proprietors of not actively to a profile linked Bluetooth devices will become non-player characters (NPCs), who—without their knowledge—transport virtual goods or information, who can be detected and used by active ARG-players with MoHED.

Such an ARG may comprise the possibility, to search the goods moving in this manner, to collect (in order to make up a greater virtual good), to pick up, to “steal”, to hide or to exchange them with other players.

Further possible game scenarios are:
1. Paper chase
2. Tag
3. Battleships
4. Take over territories
5. Deal in shares

Operators of recreation parks/theme parks may use the system according to the invention to put the above-mentioned games (also in combination) in practice.

A system and a method according to the invention is further suitable to consolidate the encounters of all currently or within a defined time period, for instance within the last five minutes, in vicinity being active and passive members with other active or passive members in any (or determined) earlier time period. To realize this, the client has to access the central memory, which is performing the consolidation of the data. During the access, data of encounters will be requested. This data result in a ranking of persons meeting often the persons someone meets currently.

By sorting these encounters by frequency, the system is able to show, which other not residing people locate often in vicinity to the present persons—an invisible sociosphere with the meaning of a “room” of social interests and interactions surrounding the user becomes visible.

The possibility is given that person who are not registered but use an identification mean of the system or method can be used for the detection of encounters with registered—active as well as passive user and/or unregistered user of the system. Thus, in an advantageous embodiment of the system unregistered users of a detectable identification mean are used to determine encounters with registered users of the system. In this manner the encounters of registered users may be determined, but also the unregistered users meeting often registered users. In case that the unregistered users will register at a later time point, it is possible to directly provide the information about encounters (also already long gone) because after the registration the identification mean can be allocated to a user.

The system or method according to the invention may be used for filing of jobs. Job applicants and employers with job offers may be brought in contact by analysing their profiles. This is especially beneficial at fairs, which are dealing with the placement of jobs.

In the field of safety engineering the use of a system according to the invention is possible, parents equip their children with a mobile device like a Bluetooth mobile. If the child comes to an area and meets an active member a message is sent to the parents, which informs that the child arrived at home, the kindergarten, or at school. The mentioned facilities may be equipped as “active members”.

Active members may also be used to detect gatherings and classify them as potential dangerous situations and to transmit them especially in combination with GPS information to security agencies or firms. Theoretically the spreading of infectious diseases may be observed with the system according to the invention.

Finally the system according to the invention may be used for the detection of encounters of pets, especially dogs. Thus the owners of animals may equip their pets as active members in order to determine the encounters of their pets with other animals.

The advantageous of the invention may be summarized as follows: The user has the advantage that no costs occur for a member, no client has to be installed or started on mobiles, no problems with compatibility, no unwillingness with respect to use the Internet on a mobile, no additional power consumption arises from active Bluetooth scanning or use of an Internet connection.

Advantages for the provider of the service are that potential user develop no concerns at registration and the long lasting anti-churn effect: Even if the first encounter happens after weeks/months, the service calls via SMS, because the mobile number was asked during first log-in.

Finally the present invention may be designated as “encounter broker”: The “active” member of the service mediates between the members of the social network or several social networks. The information about encounters collected in this manner may be sold to members without (presently active) mobile program (in form of a premium SMS) aiming at the higher readiness of mobile users to pay in comparison to classical Internet user. The determined encounter information may be sold for a fee to other social networks.

The invention is based on a five-part vicinity based and optional place-based social network and the basis of a system for determination and analysis of encounter data between single persons and groups of persons.

One part is the Mobile Hub for Encounter Detection (MoHED), a system, wherein active members of the service capture the encounters of other, passive members and transmit them to a server for analysis. Thus some active members can cause additional benefit for many passive users.

The system according to the invention comprises
1. an optional software for WINDOWS/MAC for linking Bluetooth-IDs of mobile devices with user profiles of aka-aki-members
2. a so far JAVA based (J2ME), but not restricted to it, mobile client, working as active mobile detection hub on mobiles for mobile terminal devices being in attendance, meaning in Bluetooth range which runs on about 80% of the available mobiles (but which can also be implemented on other platforms like GOOGLE Android or SYMBIAN).
3. a central server for the collection and fuzzy-logic analysis of encounters, as well as
4. an optional web based user interface and
5. a system for providing SMS and MMS.

The active user of the mobile client (second component) detects the encounters of passive users (which Bluetooth-ID is only related to their mobile, first component) and transmits them by UMTS/GPRS etc. to the central server (third component). The encounters are aggregated there and by fuzzy-logic encounter of second order in temporal and spatial dimension are determined: Because the users of the client do not serve only as endpoint, but function simultaneously as relay for transmitting encounters: Member A meets member B, which simultaneously or shortly before met member C, which will be detected by the server. If the encounters will be classified as relevant (same interests, friends or other) both members will receive, if they will not use the mobile client, a SMS informing about the relevant encounter (fifth component), but pivotal information like profile names for getting in contact will be omitted. The answer to the SMS is related to costs—not till then the member receives an MMS with portrait photo, “social graph” and common interests with the other member. Alternatively the member can load the client immediately onto the mobile or visit without costs the website of the provider in order to get information about the encounter and to get in contact with the other member (fourth component).

A special feature of the present invention is the low technical hardware standard for mobile applications, which is necessary (Bluetooth mobile is sufficient for most members, no GPS necessary, but possible), low necessary knowledge of the users (no compulsory installation of software on the mobile) and low willingness to pay (most user do not need internet connection on their mobile). The development of the MoHED enables by the reduction of the above-mentioned hurdles a precise determination of encounters at simultaneous penetration of the target group and is thus a practicable, market-driven innovation.

Not many members have to install a mobile client and pay Internet costs, wherein the majority of the members simply links the Bluetooth-ID of their mobile without any costs with their profile and participate at the system without any costs or problems with compatibility.

The low entrance hurdle allows the marketing of the solution to other social networks.

The present invention provides an all time present social network, which works even when the members do not think about it. Additionally, the members are animated to visit the

Internet presence of the service resp. the provider, willingly a mobile version thereof Turnovers are possible by a revenue share with the participating social networks from the total revenue of the profile-MMS caused by the premium-SMS.

Steps of a method for performing the method according to the invention resp. operating the system according to the invention are:
1. The operator of the system has to provide a sufficient number of active members on potential encounter places.
2. The operator has to develop a fuzzy-logic for the determination of encounters and provide the encounter-SMS and the profile-MMS.
3. The operator has to offer the linking program as white-label version and to adopt it to the partner social network.

Prerequisites for partners who want to use or offer the system according to the invention are:
1. Marketing: the partner has to promote the use of a linker for instance for a mobile for the registration step by his members. The linker is an optional software, which will be downloaded by the members of a partner network in order to link their mobile (their Bluetooth-ID) with their profile at the partner network.
2. Technique: the server of a partner network has to confirm the membership of a member for instance with a defined Bluetooth-ID and provide selected profile details to the server of the service operator, so that the encounter-SMS and the profile-MMS can be delivered.

With regard to international solutions the only relevant comparable solutions are MobiLuck (France) and BEDD (Singapore). The first one needs a hardware software installation to be able to determine encounters of member as well as the latter one, which runs only on SYMBIAN mobiles (7% market share in Germany). None of the known solutions enables participation in a vicinity based social network without software installation on an end device.

### DESCRIPTION OF THE FIGURES

The invention will be described in the following by examples without being limited to the examples. For example show

FIG. 1 UML sequence diagram “MoHED”

FIG. 2 UML sequence diagram “linker”

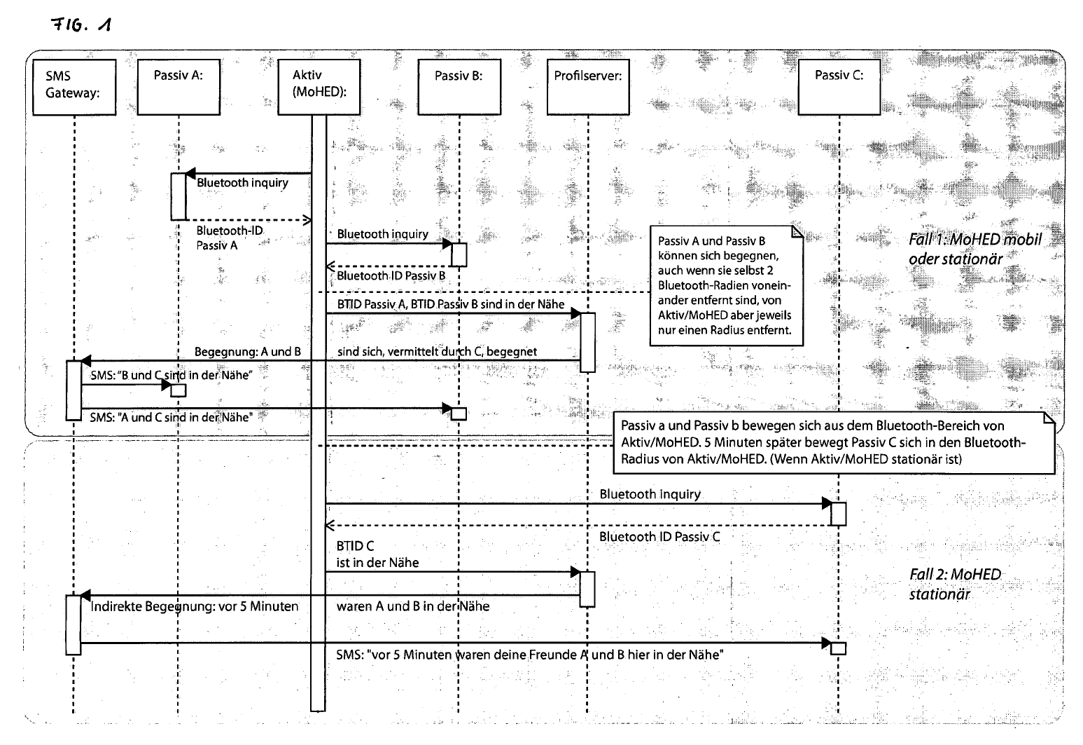

FIG. 1 shows in a flow chart as example the operating mode of the Mobile Hub for Encounter Detection (MoHED).

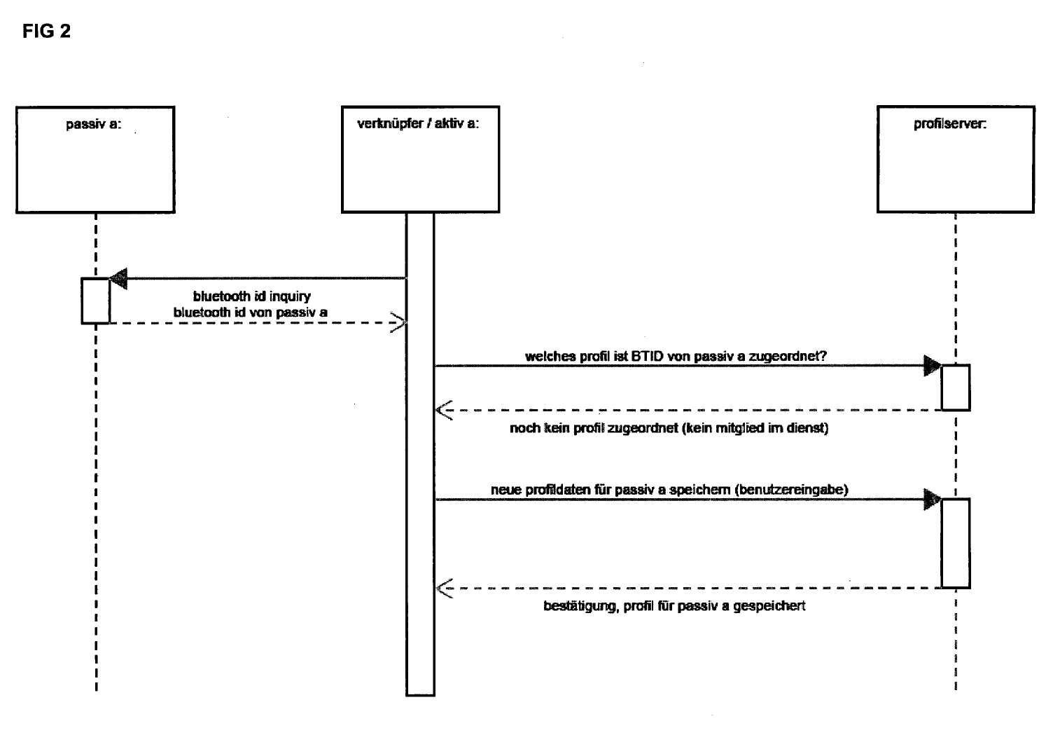

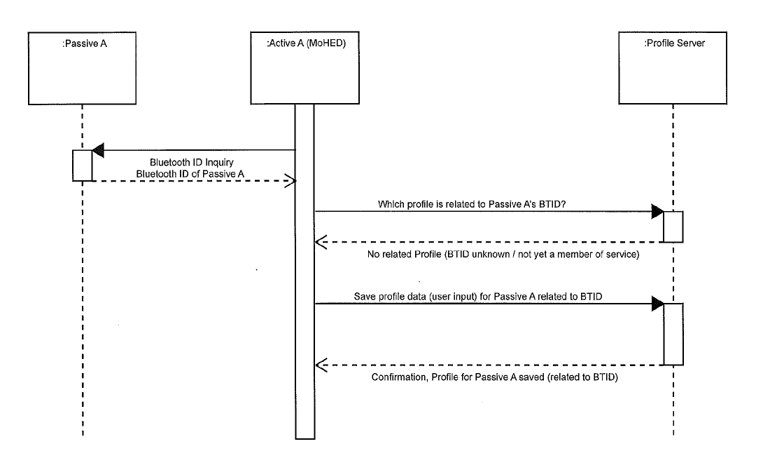

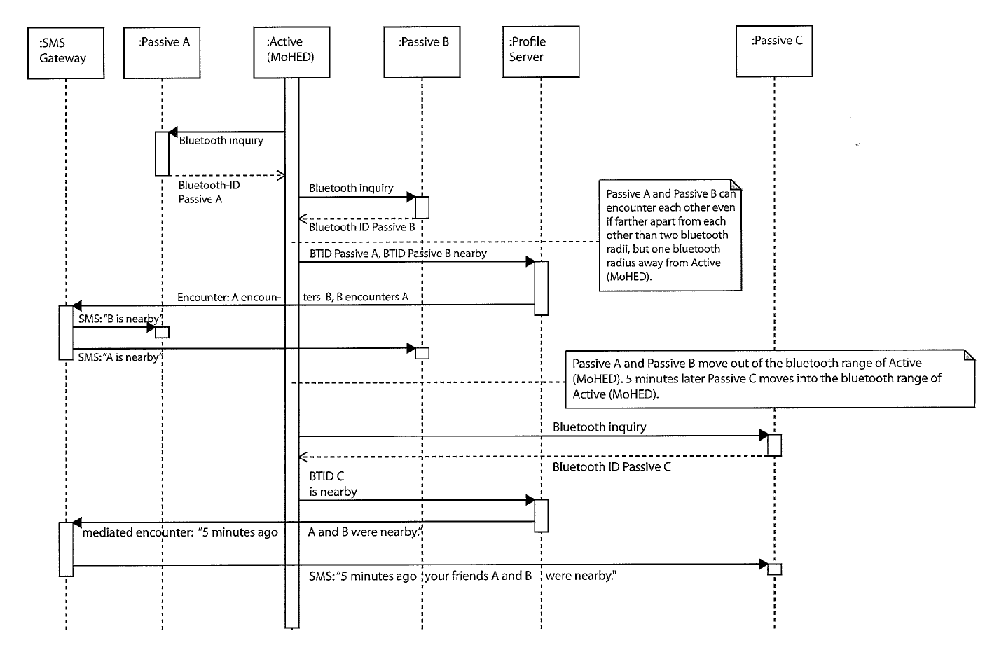

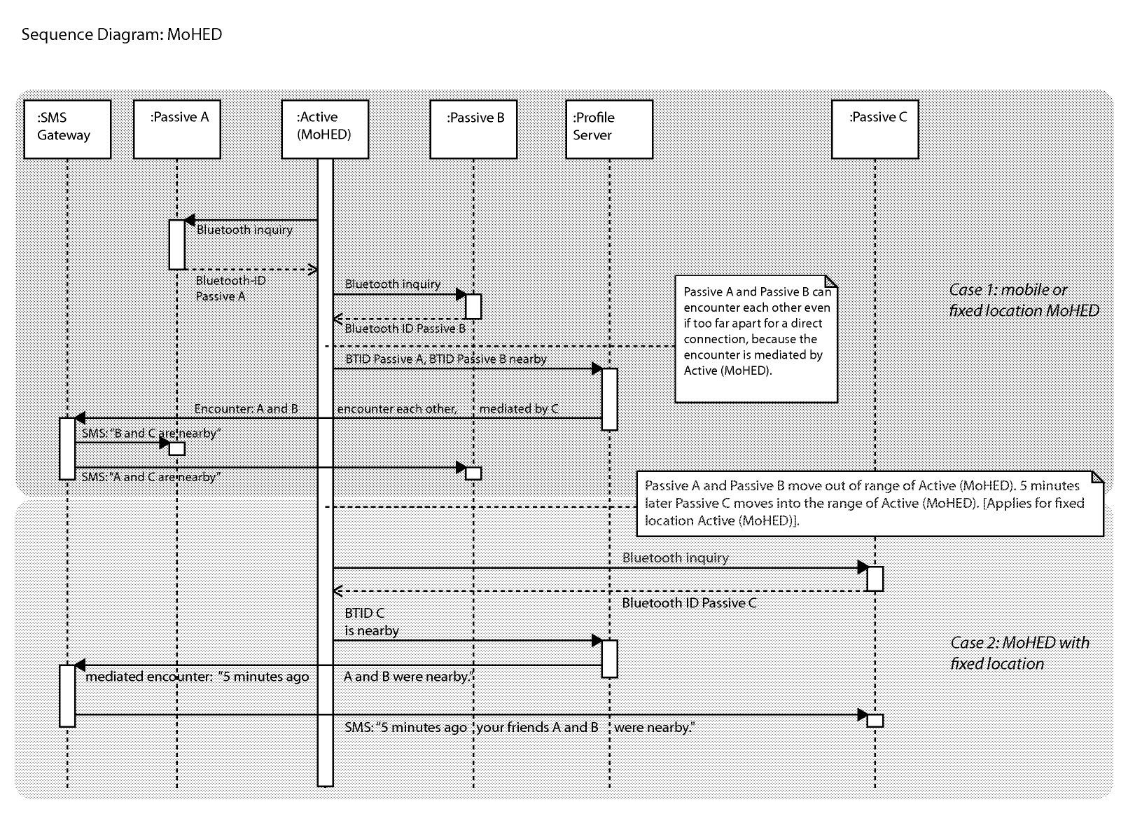

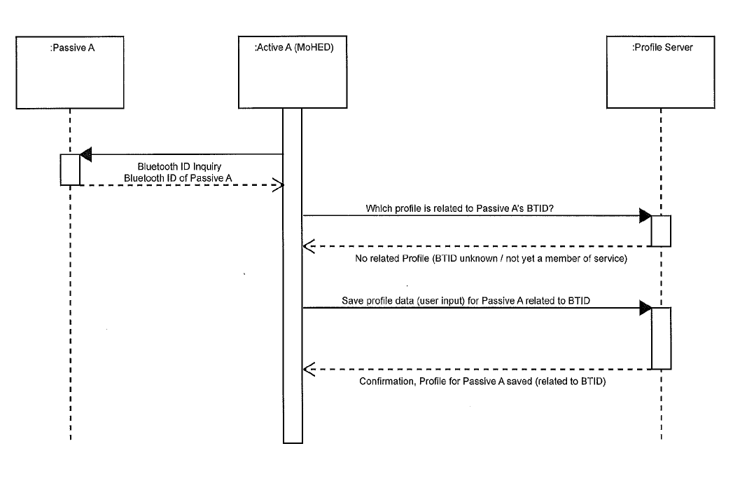

The client with MoHED technology running on the mobile terminal device of a (active) member (aktiv (mohed)) detects the Bluetooth-ID of a passive member (passiv a) in vicinity. This passive member has linked its mobile terminal device with the linker (comp. FIG. 2) and linked by this its profile. Alternatively the passive member “passive a” could be able to use the client at any earlier time point on its mobile terminal device (in the meaning of a singular successful login on the profile server), resulting also in linking its profile.

Thereupon the active member (active (mohed)) detects the Bluetooth-ID of another passive member (passive b).

The information that two passive member were at the same time in vicinity of the active member is transmitted to the profile server (profileserver). By this encounters of two passive members can be determined which have a distance of nearly two Bleutooth signal strength from each other.

The information about this (mediated) encounter will be transmitted from the profile server (profileserver) to the SMA gateway (sms gateway), which informs the passive members passiv a and passiv b via SMS about the vicinity of the respective other member as well about the active member (aktiv (Mohed)).

The MoHED system provides also information of passive members, even when only one active member is in Bluetooth range. It is not necessary that two passive members take part. The mediation of more encounters than between two passive members is further possible.

The following application is restricted to the situation that the MoHED in integrated into a stationary system, like an illuminated billboard (Citylight), and does not move: 5 minutes after the above described case the client of an active member (aktiv (mohed)) detects a new Bluetooth-ID in vicinity—the one of passive member “passiv c”—and transmits it to the profile server (profilserver). Since this encounter is in shirt temporal distance to the currently detected encounter between the active member, passive a and passive b, a SMS is sent to passive c, indicating the shortly missed encounter with passive a and passive b.

FIG. 2 shows how the linker computer program works: The linker computer program (linker/aktiv a) is started on a computer detects the Bluetooth-IDs of mobiles in vicinity. The Bluetooth-IDs will be aligned with the profile server (profilserver): If no profile link exists for such an Bluetooth-ID, the linker enables linking the respective Bluetooth-ID to a profile. The member has to authorize itself with user name and password.

After authorization the mobile device is detectable with online Bluetooth for active members, even if no client is running on the mobile device.

1. A system for the identification of encounters of users of a system, wherein the user group comprises active and passive members, with a central memory for linking identification means to the active and passive members in a registration step and active members, detecting via the client encounter with other members and/or getting directly in contact with active and/or passive members, and passive members, who are identifiable via the identification mean as members of the system and active members being mediators of encounter information, mediating either directly to active and/or passive members or indirectly through different passive members encounter information, by transmitting the respective encounters of an active member with at least a first and second passive member to the central memory, which informs via suitable communication means the passive members about their encounter.

2. A system according to claim 1, wherein the identification mean is linked to a personal profile of the respective member.

3. A system according to claim 1, wherein the identification mean is allocated to communication means, preferably a telecommunication device, mobile, PDA, notebook or a Smart Phone.

4. A system according to claim 1, wherein the identification mean is preferably located in spatial vicinity of the member and has an identification number.

5. A system according to claim 4, wherein the identification number is a Bluetooth ID, MAC-ID, telephone number, IMEI or any other numerical, clearly allocatable identifier.

6. A system according to claim 1, wherein the communication means of passive members are connectable via Bluetooth-, WLAN or other wireless connections.

7. A system according to claim 1, wherein the communication means of active and passive members detect automatically encounters with other members and active members transmit the automatically registered encounters to the central memory.

8. A system according to claim 1, wherein the central memory has a relational operator aligning transmitted encounters in temporal respect.

9. A system according to claim 1, wherein the central memory has a relational operator aligning transmitted encounters in spatial respect.

10. A system according to claim 1, wherein the central memory has a relational operator aligning transmitted encounters with respect to consistency to personal profiles and generates relational profiles.

11. A system according to claim 1, wherein an analysis operator allocates to different members a temporal and/or spatial index and analyses the indexes with regard to consistency, wherein falling below a temporal and/or spatial threshold causes a connection manager to transmit a message about the encounters to the related members.

12. A system according to claim 1, wherein the connection manager only transmits an encounters after evaluating the relational profiles and exceeding a profile-based threshold.

13. A system according to claim 1, wherein a passive member, which received a message about an encounter, gets through the relational manager access to the content of the relational profiles of the allocated members in case that the operator of the system allows access.

14. A system according to claim 13, wherein the operator allows access after payment of a fee.

15. A system according to claim 1, wherein access to the relational profile of an allocated member is carried out via SMS and/or MMS and/or the Internet.

16. A system according to claim 1, wherein the index threshold is freely definable or an encounter of order two in temporal or spatial dimension will be defined by a Fuzzy logic.

17. A method for the identification of encounters of members of the system, wherein the user group comprises active and passive users and in a registration step an identification mean is linked with the active and passive members in a central memory and only active members are able to detect via the client encounters with other members and/or getting directly in contact with active and/or passive members, and passive members are identifiable via the identification mean as members of the system and encounter information are transmitted by active members either directly to active and/or passive members or indirectly to different passive members, by transmitting the respective encounters of an active member with at least a first and second passive member to the central memory, which informs via suitable communication means the passive members about their encounter.

18. A method according to claim 17, wherein an identification mean is used, which was previously linked to a personal profile of the respective member.

19. A method according to claim 17, wherein the identification mean is allocated to a communication mean, preferably a telecommunication device, mobile, PDA, notebook or a Smart Phone.

20. A method according to any of the claim 17, wherein the identification mean is preferably located in spatial vicinity of the member and has an identification number.

21. A method according to any of the claim 17, wherein as identification number a Bluetooth ID, MAC-ID, telephone number, IMEI or any other numerical, clearly allocatable identifier is used.

22. A method according to any of the claim 17, wherein the communication means of passive members are connected via Bluetooth-, WLAN or other wireless connections.

23. A method according to any of the claim 17, wherein the communication means of active and passive members are used to detect automatically encounters with other members and active members transmit the automatically registered encounters to the central memory.

24. A method according to any of the claim 17, wherein a relational operator of the central memory is used to align the transmitted encounters in temporal respect.

25. A method according to any of the claim 17, wherein a relational operator of the central memory is used to align transmitted encounters with respect to consistency of personal profiles and to generate relational profiles.

26. A method according to any of the claim 17, wherein an analysis operator allocates to different members a temporal and/or spatial index and analyses the indexes with regard to consistency, wherein falling below a temporal and/or spatial threshold causes a connection manager to transmit a message about the encounters to the related members.

27. A method according to any of the claim 17, wherein the connection manager only transmits an encounter after evaluating the relational profiles and exceeding a profile-based threshold.

28. A method according to any of the claim 17, wherein a passive member, which has received a message about an encounter, gets through the relational manager access to the content of the relational profiles of the allocated members in case that the operator of the system allows access.

29. A method according to claim 28, wherein the operator allows access after payment of a fee.

30. A method according to any of the claim 28, wherein access to the relational profile of an allocated member is carried out via SMS and/or MMS and/or the Internet.

31. A method according to any of the claim 17, wherein the index threshold is freely defined or an encounter of order two in temporal or spatial dimension is defined by a fuzzy-logic.

32. (canceled)

33. (canceled)

34. (canceled)

35. (canceled)

36. (canceled)

37. (canceled)

38. Computer program product, which is stored in a computer readable format and comprises computer readable means by which a computer or a date processing device is caused to carry out a method according to claim 17, if the program is running on the device.
